(19) United States
(12) Patent Application Publication
(10) Pub. No.: US 2002/0027489 A1
(43) Pub. Date: Mar. 7, 2002

(54) Circuit breaker support and assembly

(76) Inventor: Patrick Letient, Saint-Quentin (FR)

Correspondence Address: PATENT OPERATION, GENERAL ELECTRIC COMPANY, 41 WOODFORD AVENUE, PLAINVILLE, CT, 06062

(21) Appl. No.: 09/681,295

(22) Filed: Mar. 14, 2001

(30) Foreign Application Priority Data
Mar. 17, 2000 (FR) 0003489

(51) Int. Cl. H01H 9/02

(52) U.S. Cl. 335/202

(57) ABSTRACT

A circuit breaker is provided with a case having a groove on the load end and a groove on the side. The grooves are sized and positioned on the case to allow several isolation accessories to be mounted to the circuit breaker. The isolation accessories include at least a terminal cover and a phase separator which electrically isolate adjacent circuit breaker poles.

### FIELD OF THE INVENTION

The present invention relates generally to circuit breakers, and more particularly to a pull-out circuit breaker case intended for use with a circuit breaker capable of attaching multiple isolation accessories.

### BACKGROUND OF THE INVENTION

Molded case circuit breakers are well known in the art. Circuit breakers of this type are connected to an electrical circuit between a power source and a circuit which requires protection against electrical faults. To connect the circuit breaker, cabling or solid busbar is connected to one side of the circuit breaker, and a second set of cables or busbar exit the opposite end of the circuit breaker. An internal switching mechanism allows the protected circuit to be coupled and decoupled from the power source. The circuit breaker also includes a sensing device that automatically switches the circuit breaker to the open or decoupled position in the event of an electrical fault.

Industrial molded case circuit breakers typically handle three or four phase circuits. Each phase of the circuit is carried through the circuit breaker in an individual pole. Some regulatory agencies such as the International Electrotechnical Commission (IEC) require that accessories be used to increase the effective distance between the poles. These distances, usually referred to as “through air” or “over surface” distances reduce the probability of electrical current flowing between adjacent phases. The most common accessories include phase barriers and terminal covers which fit between the cables mounted on each end of the circuit breaker. In the case of the terminal cover, a shield also extends over the top of the cables. Typically, installation of the terminal cover is difficult especially when the circuit breaker is already installed. Additionally the terminal cover usually requires multiple fasteners. It is thought to be advantageous to provide a terminal cover that easily installs on the circuit breaker and overcomes other disadvantages of the prior art devices.

### SUMMARY OF THE INVENTION

In an exemplary embodiment of the present invention relates to a circuit breaker having a case. The case includes a first and second groove arranged on an end and a side respectively. The grooves are positioned and sized to receive a plurality of isolation accessories including phase separators and terminal covers. The terminal covers include a plurality of knockouts that allow electrical conductors to exit the circuit breaker.

Other advantages and features will become more clearly apparent from the following description of an illustrative embodiment of the invention, given as a non-restrictive example only and represented in the accompanying drawings.

### BRIEF DESCRIPTION OF DRAWINGS

FIG. 1 illustrates an exploded perspective view of a circuit breaker with its accessories;

FIG. 2 illustrates a perspective view of a circuit breaker case;

FIG. 3 illustrates an exploded perspective view of a circuit breaker having the upper portion of the case removed with its accessories.

### DETAILED DESCRIPTION

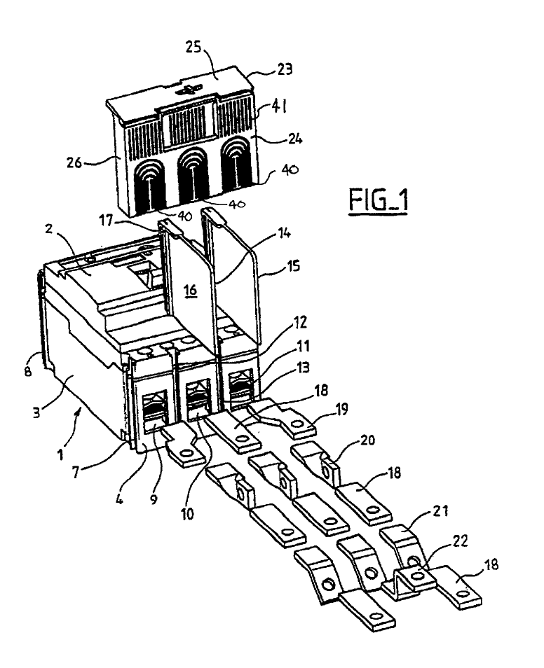

With reference to FIG. 1, circuit breaker 1 has a general parallelepiped shape with upper case 2 and four lateral sides, of which only large side 3 and load side 4 are visible.

Large side 3 is generally flat and is provided with two parallel grooves 7 and 8, one arranged in the vicinity of load side 4 and the other in the vicinity of the line side of the circuit breaker, which is not visible. The side opposite side 3 (not visible) is preferably identical to side 3 including a pair of corresponding grooves 7, 8.

Load side 4 is generally flat and is provided with three holes 9, 10 and 11, one for each pole of the circuit breaker 1. As shown in FIG. 1, the circuit breaker is configured to protect a three phase electrical circuit. Each of the holes 9-11 is sized to receive electrical conductors (not shown), which can be attached inside circuit breaker 1. The load side 4 also includes two parallel grooves 12 and 13. The groove 12 is arranged between holes 9 and 10, and groove 13 is arranged between holes 10 and 11. The line side of the circuit breaker (not shown) is preferably identical to load side 4 including grooves corresponding to grooves 11, 13. In general, for every n holes are provided, n-1 grooves will be produced.

Grooves 7, 8, 12, 13 have the same cross section with an opening, and a bottom wider than the opening. At least one longitudinal end of each groove 7, 8, 12, 13 is open. In the preferred embodiment, both longitudinal ends are open.

Different types of insulation accessories are used to provide electrical isolation between the electrical phases of the circuit breaker 1. FIG. 1 shows two phase separators 14 and 15. The phase separators 14, 15 include a generally rectangular flat plate 16 and an edge 17 arranged on one of the sides of plate 16. The edge 17 has a shape that corresponds to of grooves 7, 8 such that the edge 17 can enter and slide in one of grooves 7, 8. Phase separator 14, 15 are typically manufactured from a dielectric material, such as a flexible synthetic material. In the assembled position, the phase separators 14, 15 forms a barrier between two power connections of the circuit breaker, for example, between two connection accessories 18-22. The connection accessories can receive lugs or bars which are not shown.

Terminal cover 23 is also shown in FIG. 1. Terminal cover 23 is a single piece and has a front wall 24, an upper wall 25 and two parallel lateral walls 26. Terminal cover 23 can have phase separators parallel to the lateral walls and which are not visible in FIG. 1. A pair of edges, not visible in FIG. 1, are similar to edges 17 of phase separators 14, 15 and are arranged on the insides of the lateral walls of the terminal cover 23 so as to be housed respectively in groove 7 of large side 3 and in the corresponding groove opposite groove 7. Terminal cover 23 makes it possible to increase the insulation and to protect the users by covering the holes 9-11. The terminal cover 23 also includes a plurality of knockouts 40 arranged on the front face 24. Each knockout is arranged to be removed from the terminal cover 23 to allow the electrical conductors (not shown) to pass out of the circuit breaker 1. In addition, the terminal cover 23 includes a plurality of slots 41 arranged on the front wall 24 adjacent the knockouts 40. The slots 41 are sized to allow the gases generated during an electrical fault to exit the circuit breaker 1. The length of terminal cover 23 (in the direction of the length of wall 26) is suited to the connection accessories which are used.

A user can thus have phase separators 14, 15 or terminal cover 23 on each load side 4 of circuit breaker 1.

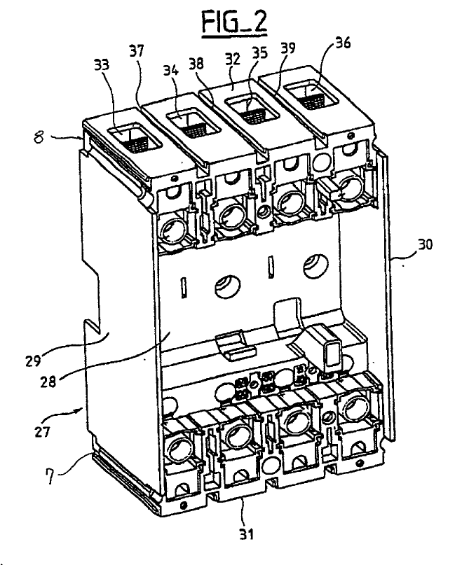

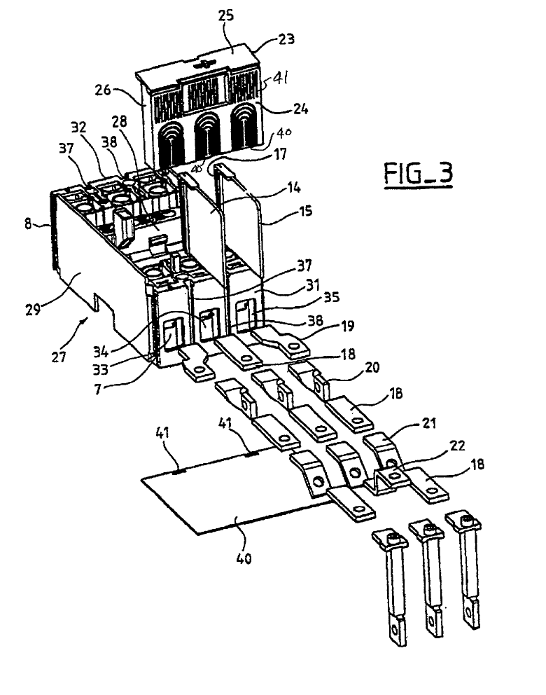

In FIGS. 2 and 3, case 27 for a circuit breaker has a general a parallelepiped shape with upper side 28 and four lateral sides, two large sides 29 and 30 and two small sides 31 and 32.

Upper side 28 is hollow and can receive circuit breaker internal components, for example, a mechanism or interrupter (not shown).

Large sides 29, 30 are generally flat and are provided with two parallel grooves 7, 8. One groove 7 arranged in the vicinity of small side 31 and the other groove 8 arranged near side 32. The distance between groove 7 of side 29,and groove 7 of side 30 is equal to the distance between the corresponding grooves of a circuit breaker having the same number of output connections and therefore of holes in small sides 31 and 32. Thus, the terminal cover 23 can be attached to the two grooves 7 or to the two grooves 8 of support 27. Terminal cover 23 can also be attached on grooves 37-39; see below.

Sides 31, 32 are generally flat and are provided with four holes 33, 34, 35 and 36 in FIG. 2 and with three holes 33, 34 and 35 in FIG. 3. The holes 33-36 are sized to receive electrical conductors (not shown), which can be attached inside case 27. The sides 31, 32 include three parallel grooves 37, 38 and 39 in FIG. 2 and two parallel grooves 37 and 38 in FIG. 3. Groove 37 is arranged between holes 33 and 34, groove 38 is arranged between holes 34 and 35, and groove 39 is arranged between holes 35 and 36. In general, for every n holes provided, n-1 grooves will be produced.

The different grooves have the same cross section with an opening, and a bottom wider than the opening. At least one longitudinal end of each groove is open. In the preferred embodiment, both longitudinal ends are open. Phase separators 14, 15 are associated with case 27.

As shown in FIG. 3, an insulation plate 40 can be attached to case 27. Plate 40 is provided with two holes 41 capable of receiving pegs, coming from the lower side of case 27 (not shown). Plate 40 makes it possible to increase the insulation with respect to the wall or to the wall or face on which the support is attached.

While this invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A circuit breaker comprising:
a case having at least one end and at least one side;
a first groove located on said at least one end; and,
a second groove located on said at least one side adjacent said at least one end.

2. The circuit breaker of claim 1 further comprising:
a first and second hole located on said at least one end, said first
groove located between said first and second hole.

3. The circuit breaker of claim 2 further comprising:
a third hole adjacent said second hole; and,
a third groove located between said second and third holes.

4. The circuit breaker of claim 3 further comprising:
an isolation member mounted to said end.

5. The circuit breaker of claim 4 wherein said isolation member is a phase separator, said phase separator having an edge disposed in said first groove.

6. The circuit breaker of claim 4 wherein said isolation member is a terminal cover, said terminal cover having an edge disposed in said second groove.

7. The circuit breaker of claim 6 wherein said terminal cover includes a plurality of knockouts on a front wall.

8. The circuit breaker of claim 7 wherein said terminal cover includes a plurality of slots in the front wall, said slots being adjacent to said knockouts.
